(19) United States
(12) Patent Application Publication
(10) Pub. No.: US 2024/0381016 A1
(43) Pub. Date: Nov. 14, 2024

(54) IMPROVEMENTS RELATING TO LOUDSPEAKER SYSTEMS

(71) Applicant: B&W GROUP LTD, Worthing, West Sussex (GB)

(72) Inventors: Ali Salehzadeh Nobari, Worthing (GB); Peter Brook, Worthing (GB); Tim Penfold, Worthing (GB)

(21) Appl. No.: 18/687,774

(22) PCT Filed: Aug. 31, 2022
(86) PCT No.: PCT/GB2022/052225

§ 371 Date: Feb. 28, 2024

(30) Foreign Application Priority Data
Aug. 31, 2021 (GB) 2112411.0

(51) Int. Cl. H04R 1/02; H04R 1/24; H04R 1/26

(52) U.S. Cl. CPC H04R 1/026; H04R 1/26; H04R 1/24; H04R 2201/029

(57) ABSTRACT

A loudspeaker system (1) comprising a first loudspeaker assembly (3) and a second loudspeaker assembly (5) is disclosed. A support bracket (7A, 7B) of the loudspeaker system (1) supports at least part of the weight of the second loudspeaker assembly (5) upon the first loudspeaker assembly (3), and holds the second loudspeaker assembly (5) in a spaced apart relation to the first loudspeaker assembly (3). The support bracket (7A, 7B) comprises a spacer (73) connected to an elastic element (82) having a lower stiffness than the spacer (73). The spacer (73) is mounted upon one of the first loudspeaker assembly (3) or the second loudspeaker assembly (5) and the clastic element (82) rests against the other one of the first loudspeaker assembly (3) or the second loudspeaker assembly (5) such that any force transmitted between the first loudspeaker assembly (3) and second loudspeaker assembly (5) via the bracket passes (7A, 7B) through the elastic element (82).

### FIELD OF THE INVENTION

The present invention concerns a loudspeaker system. More particularly, but not exclusively, this invention concerns a loudspeaker system comprising loudspeaker assemblies held in a spaced relation to one another by a support bracket. The invention also concerns associated methods of manufacture.

### BACKGROUND OF THE INVENTION

In some loudspeaker systems, the sound is emitted by several loudspeaker drivers, with each loudspeaker driver being configured to emit a limited bandwidth within the so-called “audio band”, which are the frequencies that are audible to human hearing, conventionally between 20 Hz and 20 kHz. For example, in a three-way loudspeaker system, there may be at least one low frequency (LF) loudspeaker driver configured to emit the lowest part of the audio band, for example between approximately 20 Hz to 200 Hz; at least one mid frequency (MF) loudspeaker driver configured to emit the middle part of the audio band, for example between approximately 200 Hz and 2 kHz; and at least one high frequency (HF) loudspeaker driver configured to emit the highest part of the audio band, for example between approximately 2 kHz and 20 KHz.

Loudspeaker drivers are normally located in one or more enclosures. Generally, the role of the enclosure to isolate the frontal audio emission of the diaphragm of the loudspeaker driver from the rear audio emission, to avoid destructive interference, and to react to the forces exerted on the diaphragm by the loudspeaker motor. In an ideal system, the loudspeaker diaphragm is the only moving part of the loudspeaker system, with the enclosure being a stationary, infinitely rigid, and totally motionless body. Of course, this ideal is impossible to obtain in practice, and the enclosure is always subject to a certain amount of vibration.

Where a loudspeaker system comprises two or more structurally connected loudspeaker enclosures, the vibration from a first loudspeaker driver housed in one enclosure can be transmitted to a second loudspeaker driver housed in another enclosure via the enclosures and their structural connection, thereby causing unwanted vibrations of the second loudspeaker driver and adversely affecting the quality of the sound that it emits. It is therefore desirable to reduce the transmission of vibration between loudspeaker drivers housed in different but structurally connected loudspeaker enclosures.

The present invention seeks to mitigate the above-mentioned problems. Alternatively or additionally, the present invention seeks to provide an improved loudspeaker system and associated methods of manufacture.

### SUMMARY OF THE INVENTION

The present invention provides, according to a first aspect, a loudspeaker system comprising a first loudspeaker assembly and a second loudspeaker assembly. A support bracket supports at least part of the weight of the second loudspeaker assembly upon the first loudspeaker assembly, and holds the second loudspeaker assembly in a spaced apart relation to the first loudspeaker assembly. The support bracket comprises a spacer connected to an elastic element having a lower stiffness than the spacer. The spacer is mounted upon one of the first loudspeaker assembly or the second loudspeaker assembly and the elastic element rests against the other one of the first loudspeaker assembly or the second loudspeaker assembly such that any force transmitted between the first loudspeaker assembly and second loudspeaker assembly via the bracket passes through the elastic element.

It should be understood that the term “loudspeaker system”, as used herein, is intended to cover a single structural unit formed by at least a first loudspeaker assembly structurally connected to a second loudspeaker assembly via at least one support bracket.

The first loudspeaker assembly may comprise a first loudspeaker enclosure which houses one or more loudspeaker drivers. The loudspeaker drivers of the first loudspeaker assembly may comprise one or both of a low frequency loudspeaker driver and a mid frequency loudspeaker driver. The low frequency loudspeaker driver may be configured to operate across a bandwidth of approximately 20 Hz to 200 Hz. The mid frequency loudspeaker driver may be configured to operate across a bandwidth of approximately 200 Hz and 2 kHz.

The second loudspeaker assembly may comprise a second loudspeaker enclosure which houses one or more loudspeaker drivers. In some embodiments of the invention, the second loudspeaker enclosure may house a single loudspeaker driver. The second loudspeaker enclosure may house a high frequency (HF) loudspeaker driver configured to operate across a bandwidth of approximately 2 kHz and 20 kHz. Alternatively, the second loudspeaker enclosure may house one or more of a MF or LF loudspeaker driver.

In some embodiments of the invention, the spacer may be mounted upon the second loudspeaker assembly and the elastic element may rest against the first loudspeaker assembly. For example, the spacer may be secured to the second loudspeaker assembly and the second loudspeaker assembly may be rested upon the first loudspeaker assembly by resting the elastic element against the first loudspeaker assembly. However, in other embodiments of the invention the spacer may be mounted upon the first loudspeaker assembly and the elastic element may rest against the second loudspeaker assembly. For example, the spacer may be secured to the first loudspeaker assembly and the second loudspeaker assembly may be rested upon the first loudspeaker assembly by resting the second loudspeaker assembly against the elastic element.

The spacer may comprise any suitably stiff material that is able to hold the second loudspeaker assembly in a fixed spaced relation to the first loudspeaker assembly. For example, the spacer may comprise a metallic, polymeric, or composite material. The skilled person will be aware of many suitable methods for mounting the spacer to the first or second loudspeaker assembly. For example, the spacer may be mounted using fasteners, an adhesive, or an interference fit between the bracket and the first or second loudspeaker assembly.

To achieve a desirable reduction of vibrational coupling between first and second loudspeaker assemblies which are structurally connected to one another, the resonant frequencies of the overall loudspeaker system that they form part of should ideally sit outside of the frequency band of the vibrations one is trying to prevent being transmitted between the loudspeaker assemblies; One way of doing this is to design the loudspeaker system such that its resonant frequencies are lower than the frequencies of concern. In a loudspeaker system where a first loudspeaker assembly supports the weight of a second loudspeaker assembly, such as that provided by the invention, it is particularly advantageous for the resonant frequency for which the second loudspeaker assembly has the largest modal mass to be as low as possible.

In the loudspeaker system according to the invention, the support bracket is configured such that any force that is transmitted between the first loudspeaker assembly and the second loudspeaker assembly via the bracket passes through an elastic element of the support bracket. By providing the support bracket with an elastic element having a stiffness which is lower than that of the spacer, the transmission of vibrational loads between the first and second loudspeaker enclosures is reduced, thereby reducing the resonant frequencies of the overall loudspeaker system.

The other one of the first loudspeaker assembly and the second loudspeaker assembly may comprise a channel in which the elastic element and at least part of the spacer of the bracket are received. The elastic element may rest against an internal wall of the channel such that a load path created by at least part of the weight of the second loudspeaker assembly passes between the internal wall of the channel and the elastic element.

In embodiments where the bracket is mounted to the first loudspeaker assembly, the load path passes from the internal wall of the channel into the elastic element. In embodiments where the bracket is mounted to the second loudspeaker assembly, the load path passes from the elastic element into the internal wall of the channel. In embodiments of the invention where more than one bracket is used to support the weight of the second loudspeaker assembly upon the first loudspeaker assembly the first or second loudspeaker assembly may comprise more than one channel for accommodating brackets. The channel or channels may be formed in the enclosure of the first or second loudspeaker assembly.

The elastic element may engage with more than one internal wall of channel. The elastic element may rest against internal walls of the channel in at least two perpendicular directions. In some embodiments, the elastic element may rest against internal walls of the channel in three perpendicular directions. For example, the elastic element may comprise one or more longitudinal elastic sub-elements which are configured to abut or rest against the internal walls of the channel in a direction defined by a longitudinal axis of the second loudspeaker assembly. The elastic element may comprise one or more transverse elastic sub-elements which are configured to abut or rest against the internal walls of the channel in a direction perpendicular to a longitudinal axis defined by the second loudspeaker assembly. The elastic sub-elements may be discrete. Alternatively or additionally, the elastic element may comprise a body providing multiple elastic sub-elements. In addition to mitigating the transfer of vibrations between the first and second loudspeaker assemblies, elastic sub-elements configured in this way are able to help ensure that the second loudspeaker assembly is correctly located upon the first loudspeaker assembly during manufacture of the loudspeaker system. By being configured to abut or rest against the internal walls of the channel in multiple directions, the elastic elements also help mitigate subsequent movement of the second loudspeaker assembly with respect to the first loudspeaker assembly.

An internal wall of the channel may be formed with a recess and the elastic element may be formed with a complementarily shaped projecting portion that is received in the recess, or vice versa. This arrangement advantageously helps to ensure that the second loudspeaker assembly is correctly located upon the first loudspeaker assembly when the loudspeaker system is assembled, and also helps to prevent relative movement of the first loudspeaker assembly and the second loudspeaker assembly when the loudspeaker system is moved, thereby ensuring that the second loudspeaker assembly remains correctly located upon the first loudspeaker assembly. The skilled person will be aware of many types of complementarily shaped features which are able to achieve this effect. For example, the elastic element may be formed with a lip and the internal wall of the channel may be formed with a complementarily shaped groove in which the lip is received, or vice versa.

The spacer may be mounted to the first loudspeaker assembly and the second loudspeaker assembly rests upon the elastic element of the support bracket. The support bracket may comprise a component receiving portion between the spacer and the elastic element in which an internal component forming part of the second loudspeaker assembly is at least partially received. In this configuration, the second loudspeaker assembly may not be able to be lifted away from the first loudspeaker assembly without first moving the internal component of the loudspeaker assembly. The internal component may intercept an axis defined at one end by an opening of the channel and at the other end by a location at which the elastic element rests against the second loudspeaker assembly, the shape of the bracket must therefore deviate from this axis to accommodate for the position of the internal component while still being able to support the second loudspeaker assembly. The component receiving portion may comprise, for example, a channel or aperture which is formed in the bracket. Alternatively, the bracket may be shaped to pass around the component in some other way.

The component receiving portion may comprise a further elastic element configured such that the component can only make direct contact with the support bracket via the further elastic element. Any force passing between the bracket and the second loudspeaker assembly may therefore pass through the elastic element and further elastic element of the component receiving portion. The further elastic element may form part of the elastic element. The further elastic element may be a sub-element of the elastic element. The further elastic element may be formed from substantially the same material as the elastic element of the bracket. The further elastic element of the component receiving portion is thereby configured to mitigate the transfer of vibrations between the component and the first loudspeaker assembly. For example, in embodiments of the invention where the component receiving portion provides a hole in which the component is received, the further elastic element may be configured to circumferentially surround the component such that, if the component is moved within the hole, the component comes into contact with the further elastic element. The support bracket may be configured such that the component is spaced apart from the further elastic element in normal use, and abuts the further elastic element only when the second loudspeaker assembly is moved with respect to the bracket. The configuration of the support bracket and component may therefore advantageously help ensure that the second loudspeaker assembly remains correctly located upon the first loudspeaker assembly. However, in some embodiments of the invention, the further elastic element of the component receiving portion may be configured to be in sustained contact with the component.

The component may be a tube forming part of the second loudspeaker assembly. The tube may form part of a high frequency loudspeaker assembly. The tube may be an elongate tube which engages with the rear of the high frequency loudspeaker driver. The spacer may be mounted to the first loudspeaker assembly and the second loudspeaker assembly rests upon the elastic element of the support bracket at a contact point which is located above the position of the centre of mass of the second loudspeaker assembly. Positioning the contact point above the centre of mass of the speaker in normal use is advantageous for increasing the stability of the second loudspeaker assembly upon the first loudspeaker enclosure. In this configuration, the mass of the second loudspeaker assembly is effectively hung on the support bracket in an equilibrium position such that if the second loudspeaker assembly is moved away from its equilibrium position, the weight of the second loudspeaker assembly will return it to that equilibrium position.

The elastic element may comprise any suitable material. While the term “elastic element” is used, it should be understood that it is within the scope of the invention for the elastic element to undergo some inelastic deformation in-use. However, it is preferable that the elastic element does not undergo any inelastic deformation so that the second loudspeaker assembly is held in a fixed spaced apart relation to the second loudspeaker assembly to ensure that the loudspeaker assemblies to not make direct contact with one another. The stiffness of the elastic element may be controlled by selecting a material having a suitably low elastic modulus. Therefore, the elastic modulus of the elastic element may be lower than the elastic modulus of the material forming the spacer. The elastic element may comprise a viscoelastic material. The elastic element may comprise a polymer. In preferred embodiments of the invention, materials which are less prone to creep, such as thermoset polymers, are used because they are better able to retain their shape over time while under a sustained load. Examples of suitable polymers include natural rubber and silicone-based thermoset polymers. This is advantageous where the first and second loudspeaker assemblies are spaced apart by a very small distance, because a relatively small change in shape of the elastic element may result in the first and second loudspeaker assemblies coming into direct contact with one another, thereby negating the vibrational damping effect provided by the support bracket.

The spacer of the support bracket may comprise a mounting portion for mounting the support bracket to the one of the first or second loudspeaker assemblies. The spacer of the support bracket may comprise an elongate arm portion upon which the elastic element is mounted. The mounting portion may extend in a first plane and the arm portion may extend away from the mounting portion in a second plane which is oriented at an angle to the first plane. The first plane may be oriented at between 0 and 90 degrees to the second plane. The first plane may be oriented at between 45 and 90 degrees to the second plane. The first plane may be oriented at approximately 90 degrees to the second plane. In this latter configuration the support bracket may be substantially L-shaped. In some embodiments the support bracket may be substantially T-shaped, with the mounting portion being mounted to the one of the first or second loudspeaker assemblies either side of the arm portion. The mounting portion may comprise holes for fastening the support bracket to the one of the first or second loudspeaker assemblies using fasteners, such as screws or bolts. Alternatively, the mounting portion may provide a surface for adhesively bonding the support bracket to the one of the first or second loudspeaker assemblies.

The loudspeaker system may comprise at least one further substantially identical support bracket. The support bracket(s) may support the entire weight of the second loudspeaker assembly upon the first loudspeaker assembly, and hold the second loudspeaker assembly in spaced relation to the first loudspeaker assembly. There may, in principle, be any number of support brackets for supporting the entire weight of the second loudspeaker assembly upon the first loudspeaker assembly. In some embodiments, a single support bracket may provide a plurality of spacers and, alternatively or additionally, a plurality of elastic elements. For example, two longitudinally spaced spacers and associated elastic elements may be provided in a single bracket. The second loudspeaker assembly may define a longitudinal axis. Two or more brackets may be spaced apart along longitudinal axis. A component of the loudspeaker driver of the second loudspeaker assembly may pass through component receiving portions of two or more of the brackets.

The elastic element may form part of a sleeve which is configured to be received upon a spacer or spacer portion of the spacer. The elastic element may have an end portion comprising an end face which rests against an internal end wall of the channel. The end portion may increase in length towards its end face such that the length of the end portion is greatest at the end face. The end portion may increase in width towards its end face such that the width of the end portion is greatest at the end face. Provision of a flared end portion which increases in length or width towards its end face may help to ensure contact between the elastic element and the first or second loudspeaker assembly takes place only at the end and face. This may help ensure that the contact points between the second loudspeaker assembly and the elastic elements following manufacture of a loudspeaker system remain substantially unchanged after the loudspeaker system is moved because no other part of the elastic element may be able to come into contact with the second loudspeaker assembly.

The channel may have one or more internal side walls and the internal end wall. The elastic element may only make substantial contact with the channel at its internal end wall. The loudspeaker system may be constructed so that the elastic element is moved into the channel until its end face makes contact with the internal end wall. With its end face in contact with the internal end wall, the sides of the end portion may be surrounded by the internal side walls of the channel. A distance between opposing internal side walls of the channel may not be substantially less than the length or width of the end face of the end portion so that the sides of the end portion below the end face are unable to come into substantial contact with the side walls of the channel. The second loudspeaker assembly may comprise a longitudinal axis. The length of the end portion may be measured in a direction substantially parallel with the longitudinal axis of the second loudspeaker assembly. The width of the end portion may be in a direction substantially perpendicular to the longitudinal axis of the second loudspeaker assembly. The length and width directions may define a plane, the end face may lie in a plane which is substantially parallel to the plane defined by the length and the width directions.

The end portion may have a height measured in a direction substantially perpendicular to the plane defined by the length and width directions. The length of the end portion may linearly increase towards the end face. The length of the end portion may non-linearly increase towards the end face so that, for example, the end portion has curved sides. The length of the end portion may linearly or non-linearly increase along its height. The width of the end portion may linearly increase towards the end face. The width of the end portion may non-linearly increase towards the end face. The width of the end portion may linearly or non-linearly increase along its height. The end portion may comprise a tapered region and an end region, wherein the end region comprises the end face. The tapered region may be over a first height of the elastic element and an end region and the end region may be over a second height of the elastic element. The length of the end portion over the end region may be substantially constant and equal to the length of the end face. The width of the end portion over the end region may be substantially constant and equal to the width of the end face.

The length of the end face of the elastic element may be substantially equal to the length of the internal end face of the channel. In some embodiments the length of the end face of the elastic element may be slightly greater than the length of the internal end face of the channel such that the elastic element may be compressed along its length direction when it is received in the channel with the end face of the elastic element resting against the internal end wall of the channel. In these arrangements, the close fit of the end face of the elastic and the internal end face of the channel along their length directions may mitigate any substantial movement of the second loudspeaker assembly along the length direction of the end face of the elastic element.

Alternatively or additionally, the width of the end face of the elastic element may be substantially equal to the width of the internal end face of the channel. In some embodiments the width of the end face of the elastic element may be slightly greater than width of the internal end face of the channel such that the elastic element may be compressed along its width direction when it is received in the channel with the end face of the elastic element resting against the internal end wall of the channel. In these arrangements, the close fit of the end face of the elastic and the internal end face of the channel along their width directions may mitigate any substantial movement of the second loudspeaker assembly along the width direction of the end face of the elastic element.

The elastic element may have an end portion comprising an end face. The end face may rest against an internal end wall of the channel. The end portion may comprise a block of material formed with a void. The void may be a channel which provides the elastic element with separate support portions which are spaced apart by the channel, in which case the end face of the elastic element comprises the separate end faces of the elastic elements. The length of the end portion may be measured between opposing transverse sides of the end portion, so where a void is configured to provide the end portion with separate support portions, the length of the end portion will include the lengths of the individual support portions and the size of the void between the end portions in the length direction. Similarly, the width of the end portion may be measured between opposing longitudinal sides of the end portion, so where a void is configured to provide the end portion with separate support portions, the width of the end portion will include the widths of the individual support portions and the size of the void between the end portions in the width direction. In some embodiments, the void may be a cut-out, a channel, or hole through the elastic element, below a single end face. The cut-out may run along a width direction of the end portion. The second loudspeaker assembly may comprise a longitudinal axis and a loudspeaker driver oriented to emit sound in a direction generally parallel to the longitudinal axis. The cut-out may run through the elastic element in a direction substantially perpendicular to the longitudinal axis of the second loudspeaker assembly. The width direction of the end portion may be oriented substantially perpendicular to the longitudinal axis of the second loudspeaker assembly.

The void may introduce some compliance into the load-bearing elastic element to permit some movement of the second loudspeaker assembly along its longitudinal axis while the loudspeaker system is in use. The inventors have discovered that this arrangement is advantageous for minimising the resonant frequencies of the loudspeaker assembly. In some embodiments of the invention there a load bearing elastic element may be formed with more than one void.

The spacer may form a component receiving portion in which an internal component forming part of the second loudspeaker assembly is at least partially received. The spacer may comprise two arms which provide a space there between into which a component may be received. Thus, the two arms may form the component receiving portion. The two arms may be connected by a connecting element. Alternatively, the component receiving portion may be provided by a hole through the spacer.

The spacer of the support bracket may comprise a first spacer portion spaced apart from a second spacer portion. The elastic element may be mounted upon one of the first or second spacer portions, the elastic element having a lower stiffness than the one of the first or second spacer portions. The second elastic element may be mounted upon the other one of the first or second spacer portions. The second elastic element may have a lower stiffness than the other one of the first and second spacer portions. The spacer may be mounted upon one of the first loudspeaker assembly or the second loudspeaker assembly and the first and second elastic elements rest against the other one of the first loudspeaker assembly or the second loudspeaker assembly such that any force transmitted between the first loudspeaker assembly and second loudspeaker assembly via the bracket passes through the elastic element and second elastic element. The first spacer portion may have a first height. The second spacer portion may have a second height. The first height may be greater than the second height. The first spacer portion may form a component receiving portion. The second spacer portion may form a component receiving portion. Only one of the spacer portions may form a component receiving portion. Both spacer portions may form a component receiving portion. Where the second loudspeaker assembly comprises a tube, the first spacer portion may rest against the second loudspeaker assembly at a location positioned above the tube. The first spacer portion may rest against the second loudspeaker assembly at a location positioned above the centre of mass. The second spacer portion may rest against the second loudspeaker assembly at a location positioned below the tube. The second spacer portion may rest against the second loudspeaker assembly at a location positioned below the centre of mass. The second elastic element may have any of the features described with respect to the first elastic element.

According to a second aspect, the present invention provides a method of manufacturing a loudspeaker system. The method comprises the steps of:
mounting a spacer of a support bracket to one of a first loudspeaker assembly or a second loudspeaker assembly, and
sitting the second loudspeaker assembly upon the first loudspeaker assembly by inserting an elastic element of the support bracket into a channel formed in the other one of the first loudspeaker assembly or the second loudspeaker assembly until the elastic element rests against a support point within the channel, the support point being positioned such that the support bracket supports at least part of the weight of the second loudspeaker assembly upon the first loudspeaker assembly, and in spaced relation to the first loudspeaker assembly.
   The spacer may be mounted to the first loudspeaker assembly and the elastic element may be inserted into a channel formed in the second loudspeaker assembly. The method may comprise the additional step of inserting a component into the second loudspeaker assembly such that the component passes through a component receiving portion of the support bracket. The method may also comprise the step of securing the component to the loudspeaker driver.

The component receiving portion may be configured such that the second loudspeaker assembly cannot be lifted-off the support bracket without first removing the component from the component receiving portion. The component may not need to be completely removed from the second loudspeaker assembly in order to lift the second loudspeaker assembly off the support bracket.

Where there are two or more support brackets, the method may comprise the step of sitting the second loudspeaker assembly on the two or more support brackets by inserting an elastic element of each of the support brackets into respective channels formed in the second loudspeaker assembly until their elastic elements abut support points within the respective channels. The method may comprise the step of inserting the component into the second loudspeaker assembly such that the component passes through component receiving portions of two or more support brackets. The component may be an elongate tube. The method may comprise the step of inserting the elongate tube into a hole formed in the enclosure of the second loudspeaker assembly and moving the tube along an axis defined by the second loudspeaker assembly until the tube engages the HF loudspeaker driver. The method may comprise the subsequent step of securing the tube to the HF loudspeaker driver.

It will of course be appreciated that features described in relation to the loudspeaker system of the first aspect of the invention may be incorporated into method of manufacture of the second aspect of the present invention and vice versa.

### DESCRIPTION OF THE DRAWINGS

Embodiments of the present invention will now be described by way of example only with reference to the accompanying schematic drawings of which:

FIG. 1 shows a loudspeaker system according to a first embodiment of the invention;

FIG. 2 is a cross-sectional view of the second loudspeaker assembly of the loudspeaker system shown in FIG. 1;

FIG. 3 shows a bracket used to mount the second loudspeaker assembly upon the first loudspeaker assembly of the loudspeaker system according to the first embodiment of the invention;

FIG. 4 is a cross-sectional view of the second loudspeaker assembly of a loudspeaker system according to a second embodiment of the invention;

FIG. 5 shows a bracket used to mount the second loudspeaker assembly of the second embodiment of the invention upon the first loudspeaker assembly;

FIG. 6 is an enlarged view of the area inside the box labelled A in FIG. 4;

FIG. 7 is a cross-sectional view of the second loudspeaker assembly taken along the line labelled B in FIG. 4; and

FIG. 8 is a schematic view of the cable clamp plate taken from above, showing the tortuous path of the cable around the cable clamp plate.

### DETAILED DESCRIPTION

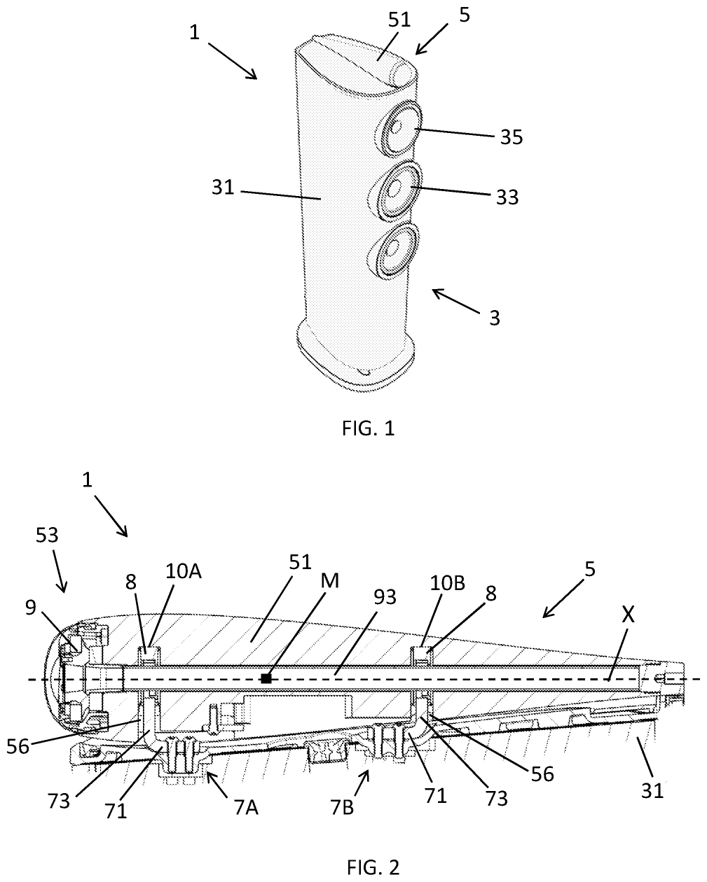

A loudspeaker system 1 according to an embodiment of the invention is shown in FIG. 1. The loudspeaker system 1 comprises a first loudspeaker assembly (LA) 3 and a second LA 5. The first LA 3 comprises a first enclosure 31 which houses a LF loudspeaker driver 33 configured to operate within a bandwidth of approximately 20 to 200 Hz and a MF loudspeaker driver 35 configured to operate within a bandwidth of approximately 200 to 2 kHz. The second LA 5 comprises an enclosure 51 which houses a high frequency loudspeaker driver 9 configured to operate within a bandwidth of approximately 2 kHz to 20 kHz. The loudspeaker system 1 is therefore operable within a bandwidth of from approximately 20 Hz to 20 kHz. However, it should be noted that in other embodiments of the invention, a loudspeaker system may comprise some other combination of LF, MF, or HF loudspeaker drivers to provide a loudspeaker system that operates within a different bandwidth.

It is well-known that, in arrangements such as this, unwanted vibrations from the LF and MF loudspeaker drivers 33, 35 can be transmitted to the HF loudspeaker driver 9, thereby reducing the quality of the sound emitted from the HF loudspeaker driver 9. To mitigate unwanted vibration of the HF loudspeaker driver 9, the second LA 5 is mounted upon the first LA 3 via two brackets 7A, 7B which are configured to reduce the transmission of vibration between the first LA 3 and second LA 5 to thereby reduce the resonant frequencies of the overall loudspeaker system 1, as shown in FIG. 2 and described in more detail below

The first LA 3 is of a typical construction that will be well understood by the skilled person, and will therefore not be described in further detail here. The second LA 5 comprises a second enclosure 51 which accommodates the HF loudspeaker driver 9. A front end 53 of the second loudspeaker enclosure 51 accommodates the basket (also known as a chassis) and other associated parts of the loudspeaker driver 9. An elongate tube 93 projects from the rear side of the HF loudspeaker driver 9 and extends along a longitudinal axis X of the second enclosure 51. The tube 93 contains a sound absorbing material and acts as an acoustic absorber for sound radiating from the rear of the HF loudspeaker driver 9.

The brackets 7A, 7B are spaced apart along the longitudinal axis X of the second LA 5 to support the weight of the second LA 5 at two support points 10A, 10B. A front bracket 7A supports the second LA 5 at a front support point 10A situated towards the front end 53 of the second LA 5, and a rear bracket 7B supports the second LA at a rear support point 10B situated towards the rear of the second LA 5. The support points are situated above the centre of mass M of the second LA 5, which increases the stability of the second LA 5 upon the first LA 3. While this arrangement is advantageous for increasing the stability of the second LA 5 upon the first LA 3, in other embodiments of the invention the support points may not be situated above the centre of mass of the second LA.

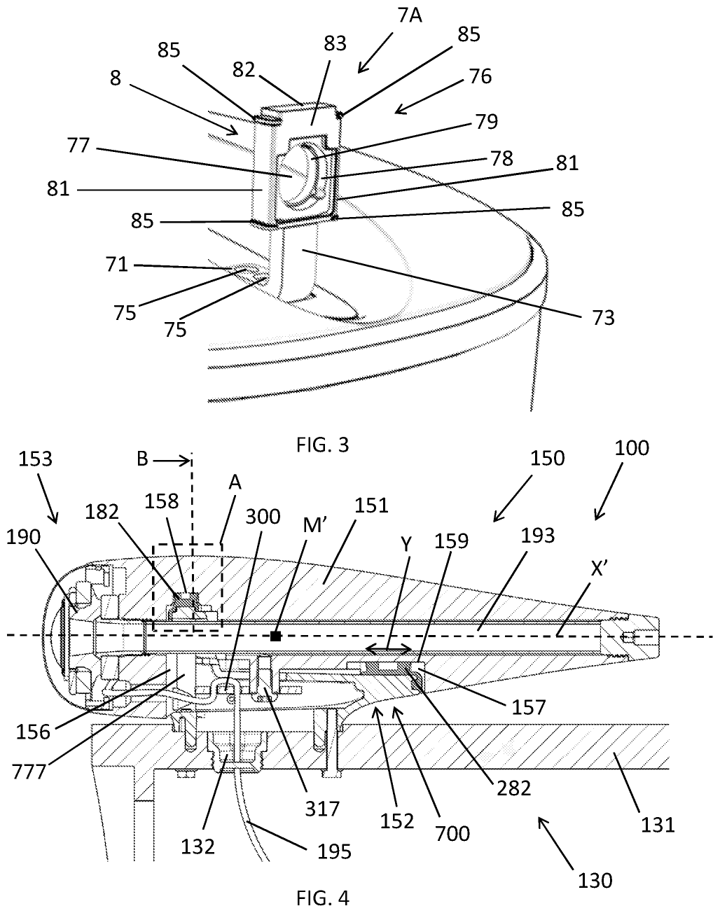

The brackets 7A, 7B are substantially identical so will therefore be described with reference to the front bracket 7A only, which is shown in more detail in FIG. 3.

The bracket 7A comprises an L-shaped steel element which provides a spacer portion 73 and a substantially perpendicular mounting portion 71 which has a plurality of holes 75 for fastening the bracket 7A to the first LA 3 using fasteners. However, it will be appreciated that in other embodiments of the invention the bracket may be configured to be mounted to the first LA 3 some other way. Together spacer portion 73 and mounting portion 71 hold second LA 5 in a fixed spaced-relation to the first LA 3. Steel has a stiffness that is appropriate for achieving this effect. However, other suitably stiff materials, such as other metals, alloys, polymers, or composites may be used in other embodiments of the invention. At the distal end of the spacer portion 73, the bracket 7A comprises a tube-receiving portion 76 formed with a hole 77 which is dimensioned to receive the tube 93 of the second LA 5. The hole 77 has an internal circumferential surface 78 that is lined with an elastic tube element 79 consisting of a layer of thermoset polymer.

Around the outer edges of the tube-receiving portion 76 the bracket 7A comprises a thermoset polymer sleeve 8 having an approximate profile of a square defined in a plane that is substantially perpendicular to the axis X. The sleeve 8 provides lateral elastic elements 81 along the outer lateral edges of the tube-receiving portion 76, either side of the hole 77, and a load-bearing elastic element 82 along the top edge of the tube-receiving portion 76, above the hole 77. The lateral elastic elements 81 and the load-bearing elastic element 82 thereby defining three sides of the square defined by the sleeve 8. At approximately each corner of the square, the sleeve 8 is formed with a lip 85 which projects away from the tube-receiving portion 76 in a lateral direction.

As can be best seen in FIG. 2, the length of the sleeve 8 along the longitudinal axis X is greater than the thickness of the steel element which provides the tube-receiving portion 76 such that the sleeve 8 provides longitudinally spaced surfaces on opposite sides of the tube-receiving portion which act as longitudinal elastic elements 83. It will be appreciated that, while a single sleeve 8 provides a convenient means of providing elastic elements 79, 81, 82, 83, the invention is not limited to the use of a sleeve. Furthermore, in other embodiments of the invention, fewer elastic elements may be provided. In other embodiments of the invention one or more elastic elements may be provided in other ways. For example, a plurality of discrete elastic elements may be provided, or the elastic elements may be provided in a plurality of bodies. Furthermore, a thermoset polymer was chosen as the material for the elastic elements 79, 81, 82, 83 not only because of its relatively low elastic modulus, but because of its relatively low susceptibility to creep. In the presently described embodiment of the invention, the second LA 5 is held by the brackets 7A, 7B at a distance of approximately 1 millimetre from the first LA 3. Therefore, a small change in the shape of the load-bearing elastic element 82 due to creep under the sustained load of the second LA 5 may result in the second LA 5 moving into direct contact with the first LA3, thereby negating any reduction in vibrational coupling provided by the brackets 7A, 7B. However, it will be appreciated that in other embodiments of the invention other suitable materials may be used for the elastic elements. Furthermore, creep may not be an issue in embodiments where the loudspeaker assemblies are spaced apart by a greater distance, therefore creep will not play a role in the material selection process for those embodiments.

The second loudspeaker enclosure 51 is formed with two channels 56 which are spaced apart along the longitudinal axis X in which the tube-receiving portions 76 and the spacer portions 73 of the brackets 7A, 7B are received. The load-bearing elastic elements 82 of the brackets 7A, 7B abut the internal end surfaces of their respective channels 56 at the front and rear support points 10A, 10B such that the entire weight of the second LA 5 is carried by load-bearing elastic elements 82 and is transferred to the first LA 3 via a load path passing through the brackets 7A, 7B. Within each channel 56, the lips 85 of the lateral elastic elements 81 sit within complementarily shaped grooves (not shown) formed inside the channels 56. The engagement of the lips 85 with the grooves helps ensure that the second LA 5 is correctly located upon the first LA 3 during assembly of the loudspeaker system 1. This feature also helps ensure that the second LA 5 remains correctly located upon the first LA 3 when the loudspeaker system 1 is moved. It will of course be appreciated that in other embodiments of the invention, other types of complementarily shaped features which engage to ensure that the second LA 5 is correctly located upon the first LA 3 may be used to provide the functionality of the lips and grooves of the presently described embodiment of the invention.

As can also be seen in FIG. 2, the tube 93 of the second LA 5 passes through the hole 77 in each of the brackets 7A, 7B. The second LA 5 therefore cannot be lifted off the brackets 7A, 7B without first removing the tube 93. Furthermore, the second LA 5 is prevented from substantial movement in the transverse and vertical directions by the tube 93 engaging with the tube elastic elements 79. This arrangement therefore helps ensure that the second LA 5 remains correctly positioned with respect to the first LA 3 during transport of the loudspeaker system 1. Similarly, to assemble the loudspeaker system 1, the second LA 5 must first be lowered onto the brackets 7A, 7B, which are fastened in place upon the first LA 5, before inserting the tube 93 into the holes 77 of the brackets 7A, 7B. It is noted that the holes 77 and elastic tube elements 79 are dimensioned such that the elastic tube elements 79 are spaced-apart from the tube 93 in normal use of the loudspeaker system 1. However, in the event that there is any minor dislocation of the tube relative to the brackets 7A, 7B, the elastic tube element 79 reduces the transmission of vibration between the tube 93 and the brackets 7A, 7B. Furthermore, the lengths of the spacer portions 73 of the brackets 7A, 7B are such that the second LA 5 is held in a spaced-apart relation to the first LA 3, with the minimum distance between the first LA 3 and second LA being approximately 1 millimetre. In other embodiments of the invention the spacer portions of the brackets may be configured to space the LAs apart by a different distance.

Because the second LA 5 is spaced apart from the first LA 3, the only path for vibrations from the LF and MF loudspeaker drivers 33, 35 to the HF loudspeaker driver 9 is via the brackets 7A, 7B. While each bracket 7A, 7B, is fastened to the first LA 3 via its respective steel mounting portion 71, which will receive vibrations from the LF and MF loudspeaker drivers 33, 35, substantially all of the weight of the second LA 5 is carried by the load-bearing elastic elements 82, and the lips 85 of the lateral elastic elements 81 are engaged with the grooves in their respective channels 56. If there is any longitudinal movement of the second LA 5 with respect to the first LA 3, internal walls of the channels 56 of the second LA abut the longitudinal elastic elements 83. Furthermore, the tube 93 is only able to come into contact with the elastic tube elements 79 if there is any movement of the second LA 5 with respect to the first LA 3. The second LA 5 is therefore only able to come into contact with the elastic elements 79, 81, 82, 83 of the brackets 7A, 7B, so any vibrational force emanating from the LF or MF loudspeaker drivers 33, 35 can only be passed into the second LA 5 via the elastic elements 79, 81, 82, 83. Therefore, the elastic elements 79, 81, 82, 83 reduce the vibrational energy transmitted from the LF and MF loudspeaker drivers 33, 35 into the second LA 5. Configured as such, the brackets 7A, 7B substantially reduce the resonant frequencies of the loudspeaker system 1.

While the loudspeaker system 1 described above comprises two brackets 7A, 7B, it will be appreciated that it is within the scope of the invention for any number of brackets to be used to support a second LA upon a first LA. In some embodiments, a single support bracket supporting a second LA at a single support point may be used. In other embodiments a single bracket may be configured to provide a plurality of spaced-apart spacer elements connected to a plurality of elastic elements which support a loudspeaker assembly at multiple support points. Therefore, a single bracket may be used to provide the functionality of both of the support brackets 7A, 7B of the first embodiment of the invention.

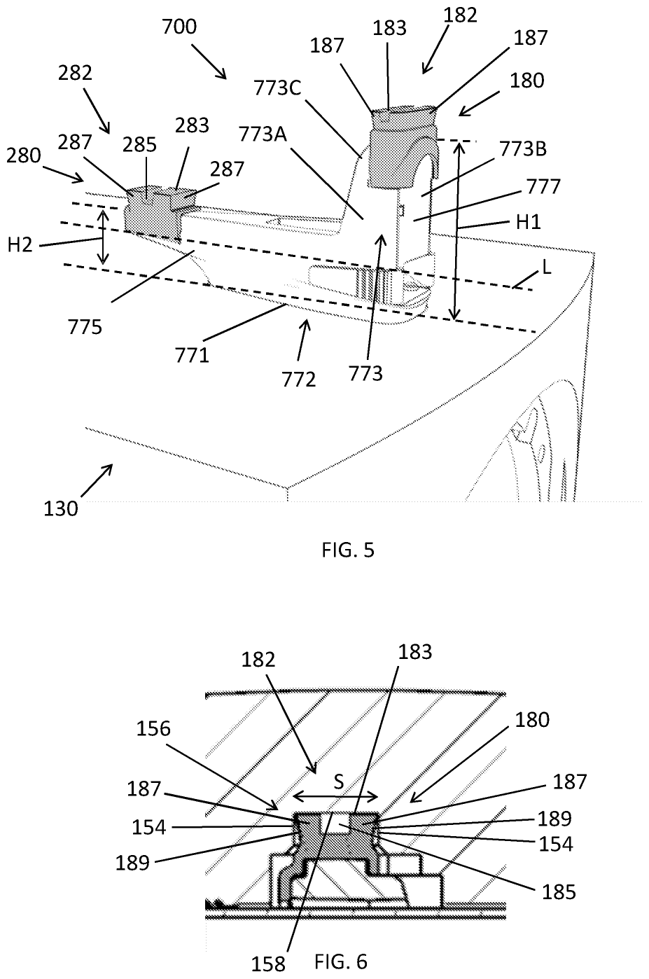

A cross-sectional view of part of a loudspeaker system 100 according to a second embodiment of the invention is shown in FIG. 4. Similarly to the loudspeaker system 1 according to the first embodiment of the invention described above, the loudspeaker system 100 of the second embodiment comprises a first LA 130 comprising a first enclosure 131 which houses a LF loudspeaker driver (not shown) and a MF loudspeaker driver (not shown) and a second LA 150 comprising an enclosure 151 which houses a high frequency loudspeaker driver 190. To mitigate unwanted vibration of the HF loudspeaker driver 190, the second LA 150 is mounted upon the first LA 130 via a single bracket 700, which is shown in FIG. 5 without the presence of the second LA 150. The bracket 700 is configured to reduce the transmission of vibration between the first LA 130 and second LA 150 to thereby reduce the resonant frequencies of the overall loudspeaker system 100.

The first LA 130 is of a typical construction that will be well understood by the skilled person, and will therefore not be described in further detail here. The second LA 150 comprises a second enclosure 151 which accommodates the HF loudspeaker driver 190. A front end 153 of the second loudspeaker enclosure 151 accommodates the basket (also known as a chassis) and other associated parts of the loudspeaker driver 190. An elongate tube 193 projects from the rear side of the HF loudspeaker driver 190 and extends along a longitudinal axis X′ of the second enclosure 151. The tube 193 contains a sound absorbing material and acts as an acoustic absorber for sound radiating from the rear of the HF loudspeaker driver 190.

Driving signals are provided to the loudspeaker driver 190 by a cable 195 which is attached to the loudspeaker driver 190, and which runs into the second enclosure 151 from the first LA 130 via an aperture 132 which is formed in first enclosure 131 and which is situated below the bracket 700. The cable 195 is held in place within the second enclosure 151 by a cable clamp plate 300, which is shown schematically from above in FIG. 8.

The cable clamp plate 300 comprises an elongate plate 301 formed with a first cut-out 303 which extends into the plate 301 from a first side 305 of the plate 301 and a second cut-out 309 which is spaced apart from the first cut-out 303 along the plate 301, and which extends into the plate 301 from a second, opposite side 311 of the plate 301. As can be seen in FIG. 4 and FIG. 8 the cable 195 runs from the aperture 132 of the first LA 130 upwardly through the first cut-out 303 of the plate 301, then passes over a first section 313 of the plate 301 and down through the second cut-out 309. The cable then passes underneath a second section 315 of the plate 301 and towards the loudspeaker driver 190. The cable clamp plate 300 is fastened to the second enclosure 151 by a fastener 317 which is passed through a hole 319 in the plate 301 and fastened into the second enclosure 151. The tortuous path of the cable 195 around the cable clamp plate 300, which is fastened to the second enclosure 151, fixes the position of the cable 195 relative to the second enclosure 151, and thereby helps to prevent the cable 195 moving and coming into contact with the second enclosure 151 or bracket 700 when the loudspeaker system is moved. Contact between the cable 195 and the second enclosure 151 or bracket 700 is undesirable because the cable 195 could then provide a path for unwanted vibrations to be passed from the first LA 130 to the second LA 150.

The bracket 700 comprises a steel spacer 772 comprising a foot 771 which serves as a mounting portion to enable the bracket 700 to be fastened to an upper surface of the first LA 130 using fasteners. However, it will be appreciated that in other embodiments of the invention the bracket 700 may be configured to be mounted to the first LA 130 some other way. Furthermore, while the bracket 700 is constructed from steel, in other embodiments other suitable materials may be used, including but not limited to, metals, alloys, polymers and composites. The spacer 772 comprises a front spacer portion 773 having a height H1 and a rear spacer portion 775 which is spaced apart from the front spacer portion 773 along a longitudinal axis L of the bracket 700 and which has a height H2. The height H2 being less than the height H1.

It should be noted that, in the presently described embodiment of the invention, the loudspeaker system 100 has been aesthetically designed such that the bracket 700 is visible (unlike the loudspeaker system 1 of the first embodiment of the invention where the brackets 7A and 7B are hidden from view). For this reason, the shape of the bracket 700, particularly around the rear spacer portion 775, has been dictated in part by aesthetics. In particular, the bracket 700 has been shaped such that its visible part conforms with the aesthetic tear-drop shape of the second LA 150, as can be best seen in FIG. 4. In other embodiments of the invention, the bracket may be shaped differently depending on whether the bracket is visible in use and on the aesthetics of the loudspeaker system that it forms part of.

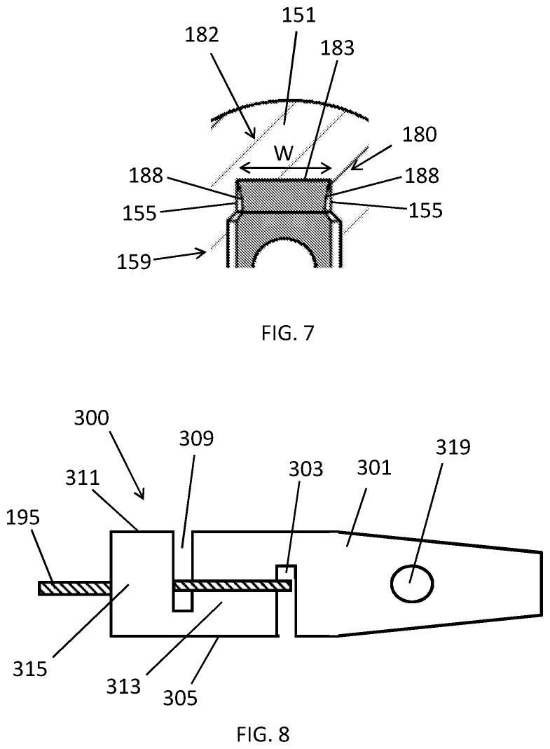

As can be seen in FIG. 5, the front spacer portion 773 comprises two arms 773A, 773B which are spaced apart in a direction transverse to the longitudinal axis L to provide a provide a tube-receiving channel 777 which is dimensioned to receive the tube 193 of the second LA 150. The distal ends of the arms 773A, 773B are joined by a connecting element 773C which carries a front sleeve 180 which is made from a thermoset polymer. The front sleeve 180 is shaped to snugly fit over the connecting element 773C so that it is retained upon the connecting element 773C in use. The front sleeve 180 comprises a load-bearing elastic element 182 which projects upwardly from the connecting element 773C. As can be best seen from FIG. 6 and FIG. 7, the load-bearing elastic element 182 is formed from a block of thermoset polymer that has an end portion which is flared such that its length S parallel to the longitudinal axis L and its transverse width W increase towards the distal end 183 of the load-bearing elastic element 182, with the length S and width W being a maximum at the distal end 182 of the element 182. As can be best seen in FIG. 6, the load-bearing elastic element 182 is formed with a channel 185 which runs transversely along the width W of the element 182 such that the load-bearing elastic element 182 is provided with two support portions 187 which are spaced apart by the channel 185 in a direction parallel to the longitudinal axis L.

At the rear end of the bracket 700, the rear spacer portion 775 carries a rear sleeve 280 which is made from a thermoset polymer. The rear sleeve 280 is shaped to snugly fit over and around the top of the rear spacer portion 775 in order to be retained upon the rear spacer portion 775 in use. Similarly to the front sleeve 180, the rear sleeve 280 comprises a load-bearing elastic element 282 which projects upwardly from the rear spacer portion 775 and which is flared such that its length parallel to the longitudinal axis L and its transverse width increase towards the distal end 283 of the load-bearing elastic element 282, with its length and width being a maximum at the distal end 282 of the element 282. The rear load-bearing elastic element 282 is also formed with a channel 285 which runs transversely along the width of the element 282 such that the element 282 is provided with two support portions 287 which are spaced apart by the from channel 287 in a direction parallel to the longitudinal axis L. The flared shape of the load-bearing elastic elements 182, 282 ensure that only their distal ends 183, 283 make contact with the second enclosure 151. This arrangement helps ensure that the resonant frequencies of the as manufactured loudspeaker system 100 more closely replicate the target design resonant frequencies than in arrangements where the exact contact points between a bracket and a supported LA can vary following manufacture, and also helps ensure that the distal ends 183, 283 of the load-bearing elastic elements 182, 282 remain the only contact points between the bracket 700 and the second enclosure 151 in the event that the second LA 150 is moved slightly in relation first LA 130 to the during, for example, transport of the loudspeaker system 100.

The second loudspeaker enclosure 151 is formed with a cut-out 152 which provides a front channel 156 and a rear channel 157 which are spaced apart along the longitudinal axis X′, and in which the respective front and rear elastic elements 182, 282, and front and rear spacer portions 773, 775 of the bracket 700 are received. The distal ends 183, 283 of the front and rear load-bearing elastic elements 182, 282 abut the internal end surfaces 158, 159 of their respective channels 156, 157, with the tube 193 passing through the tube-receiving channel 777. In this embodiment of the invention, the front spacer portion 773 is configured with a greater height H1 than the height H2 of the rear spacer portion 775, and the front channel 156 has a greater depth than the rear channel 157, so that the front load-bearing elastic element 182 supports the second loudspeaker enclosure 151 above the centre of mass M′ of the second LA 150 and the rear load-bearing elastic element 282 supports the second loudspeaker enclosure 150 below the centre of mass M′ (below the tube 193, as can be seen in FIG. 4). The entire weight of the second LA 150 is carried by the front and rear load-bearing elastic elements 182, 282 and is transferred to the first LA 130 via a load path passing through the bracket 700.

As can be best seen in FIG. 6, which depicts a cross-sectional view of the front load-bearing elastic element 182 in situ within the front channel 156, the length of the internal end surface 158 of the front channel 156 parallel to the longitudinal axis X′ is approximately equal to the length S of the of the distal end 183 of the load-bearing elastic element 182 (the length S being the distance along the longitudinal axis X′ between the opposing transverse sides 189 of the elastic element 182, which in this case includes the size of the channel 185 along the X′ axis). Similarly, as can be seen in FIG. 7, which depicts a cross-sectional view along the longitudinal axis X′ of the front load-bearing elastic element 182 in situ within the front channel 156, the width of the internal end surface 158 of the front channel 156 is approximately equal to the width W of the distal end 183 of the load-bearing elastic element 182 (the width W being the distance along a direction perpendicular to the longitudinal axis X′ between the opposing longitudinal sides 188 of the elastic element 182).

The cross-sectional views of FIG. 6 and FIG. 7 also illustrate how the flared shape of the front load-bearing elastic element 182 ensures that its distal end 183 which rests against the internal end surface 158 of the front channel 156 is the only part of the elastic element 182 which makes contact with the second enclosure 151. As can be seen, the distance between the opposing longitudinal internal side walls 154 of the channel 156 which are spaced apart along the axis X′ is at least equal to the length S of the distal end 183 of the elastic element. Also, the distance between the opposing transverse internal side walls 155 of the channel 159 which are spaced apart in the direction perpendicular to the axis X′ is at least equal to the width W of the distal end 183 of the elastic element 182. The width and length of the front load-bearing elastic element 182 away from its distal end are less than the distances between the internal side walls 154, 155 of the channel, so the elastic element 182 can only make contact with the second enclosure at its distal end 183. As mentioned above, the rear load bearing elastic element 282 is also flared to ensure that its distal end 283 which rests against the internal end surface 159 of the rear channel 157 is the only part of the elastic element 282 which makes contact with the second enclosure 151.

Because the length S and width W of the distal end 183 of the front load-bearing elastic element 183 are equal to the corresponding internal dimensions of the front channel 156 there is no room for movement of the front load-bearing elastic element 182 within the front channel 156 along the longitudinal axis X′ or in the transverse direction. The close fit between the distal end of the front load-bearing elastic element 182 and the internal end surface 158 of the front channel 156 therefore ensures that the second LA 150 cannot be substantially moved with respect to the front load-bearing elastic element 182 when it is in place upon the bracket 700.

Similarly, the width of the distal end 283 of the rear load-bearing elastic element 282 is also approximately equal to the width of the internal end surface 159 of the rear channel 157 in order to prevent movement of the rear load-bearing elastic element 282 within the rear channel 157 in a direction transverse to the longitudinal axis X′. However, as can be seen in FIG. 4, the length Y of the rear load-bearing elastic element 282 is less than the length of the internal end surface 159 of the rear channel 157 so that the rear load-bearing elastic element 282 is free to move along the longitudinal axis X′ within the rear channel 157. The second LA 150 is thereby held in a fixed position on the longitudinal axis X′ by the front load bearing elastic element 182 only, whereas both the front and rear load bearing elastic elements 182, 282 hold the second LA in a fixed position in the direction transverse to the longitudinal axis X′. This arrangement helps ensure that the second LA 150 cannot be substantially moved with respect to the bracket 700 when the loudspeaker system is moved or, in an extreme case, if the loudspeaker system is dropped, for example during transport. Movement of a supported LA may change the contact points or weight distribution between the load bearing elastic elements, which may in turn change the resonant frequencies of the loudspeaker system. Ensuring that the second LA 150 remains in a substantially fixed position therefore helps ensure that the resonant frequencies of the loudspeaker system are not changed following an impact or other dynamic load.

Ideally the resonant frequencies of a loudspeaker system should be lower than the human audible range, so less than about 20 Hz. Such low resonant frequencies may be achievable through the use of very soft load-bearing elastic elements. However, if the material used to make the elastic elements is too soft, the load-bearing elastic elements may be unable to statically support a LA over the lifetime of the loudspeaker system. A suitably hard material must therefore be used. In the presently described embodiment of the invention, the thermoset that the sleeves 180, 280 which form the load-bearing elastic elements 182, 282 are manufactured from is a compression moulded silicone. Compression moulded silicone typically has a hardness variability of +/−5 Shore A, so the softer the material used, the greater effect this variation has on the properties of the load-bearing elastic elements. For example, using a compression moulded silicon having a hardness of approximately 10 Shore A could result in load bearing elastic elements having a hardness variability of +/−50%, which could result in an undesirable variability in resonant frequencies between different loudspeaker systems which are designed to have the same target resonant frequencies. In the present embodiment of the invention, a compression moulded silicon having a hardness of approximately 20 Shore A has been found to be acceptable. However, in other embodiments of the invention other suitable materials may be used, including softer or harder materials, as appropriate.

As mentioned above, the load-bearing elastic elements 182, 282 are each formed with a respective channel 185, 285 which runs transversely with respect to the longitudinal axis L of the bracket 700. The purpose of the channels 185, 285 is to soften the load-bearing elastic elements 182, 282 in order to compensate for the hardness of the compression moulded silicon. In particular, the channels 185, 285 provide a void in the block of material forming each of the elastic elements 182, 282 which introduces some compliance into the load-bearing elastic elements 182, 282 to permit some movement of the second LA 150 along the longitudinal axis X′ while the loudspeaker system 100 is in use. The inventors have discovered this is arrangement is advantageous for minimising the resonant frequencies of the loudspeaker assembly.

Furthermore, the inventors have also discovered that, in order to minimise the resonant frequencies of the loudspeaker assembly, it is desirable to inhibiting rotational movement of the second LA 150 about the longitudinal axis X′, or any movement of the LA 150 transverse to that axis, so no compliance-introducing features are provided in the load-bearing elastic elements 182, 282 to encourage such movement. However, in other embodiments of the invention, the load-bearing elastic elements may be designed with some compliance to increase the amount by which the second LA is able to move in those directions. While a channel has been introduced into the load bearing elastic elements of the present embodiment of the invention to provide each load bearing elastic element with two support portions, in other embodiments of the invention the compliance of the load-bearing elastic elements may be increased by providing a plurality of channels and a plurality of support portions, or by providing one or more holes or other forms of void in the load-bearing elastic elements. Furthermore, any voids may be filled with a different material, which may have a different hardness to the material from which the rest of the load-bearing elastic element is formed.

Whilst the present invention has been described and illustrated with reference to particular embodiments, it will be appreciated by those of ordinary skill in the art that the invention lends itself to many different variations not specifically illustrated herein. For example, while the speaker systems 1, 100 described above comprise arrangements in which the support brackets 7A, 7B, 700 are mounted to a first LA and in which a second speaker LA rests upon the load-bearing elastic elements 82, 182, 282 in other embodiments of the invention support brackets may instead be mounted to the second LA. In these embodiments the spacer portions of the support brackets may effectively form legs on which the second LA is stood upon the first LA, with load-bearing elastic elements connected to the spacer portions forming feet which engage with the first LA to mitigate the passage of vibrations between the first and second LAs. Furthermore, the invention is not limited to speaker systems comprising only two LAs; in principle, any number of LAs could be assembled using brackets comprising spacer portions and elastic portions to form an array of LAs which are structurally connected in a way that mitigates the transfer of vibrations between the LAs. As an example, a third LA could be mounted upon the second LA of the loudspeaker systems 1, 100 using brackets having spacer portions and elastic portions. In this case it may be necessary to modify the brackets 7A, 7B, 700 to account for the extra weight of the third LA. In another embodiment, a loudspeaker system comprises an assembly comprising a separate LF, MF, and HF LAs held in a spaced-apart relation by brackets comprising spacers and elastic portions.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A loudspeaker system comprising a first loudspeaker assembly and a second loudspeaker assembly,
wherein a support bracket supports at least part of the weight of the second loudspeaker assembly upon the first loudspeaker assembly, and holds the second loudspeaker assembly in a spaced apart relation to the first loudspeaker assembly, the support bracket comprising a spacer connected to an elastic element having a lower stiffness than the spacer,
wherein the spacer is mounted upon one of the first loudspeaker assembly or the second loudspeaker assembly and the elastic element rests against the other one of the first loudspeaker assembly or the second loudspeaker assembly such that any force transmitted between the first loudspeaker assembly and second loudspeaker assembly via the bracket passes through the elastic element.

2. A loudspeaker system according to claim 1, wherein the other one of the first loudspeaker assembly and the second loudspeaker assembly comprises a channel in which the elastic element and at least part of the spacer of the bracket are received, and wherein the elastic element rests against an internal wall of the channel such that a load path created by at least part of the weight of the second loudspeaker assembly passes between the internal wall of the channel and the elastic element.

3. A loudspeaker system according to claim 2, wherein the elastic element rests against internal walls of the channel in at least two perpendicular directions.

4. A loudspeaker system according to claim 2 or claim 3, wherein an internal wall of the channel is formed with a recess, and wherein the elastic element is formed with a complementarily shaped projecting portion that is received in the recess.

5. A loudspeaker system according to any preceding claim, wherein the elastic element has an end portion comprising an end face which rests against an internal end wall of the channel, and wherein the end portion increases in length towards its end face such that the length of the end portion is greatest at the end face.

6. A loudspeaker system according to any preceding claim, wherein the elastic element has an end portion comprising an end face which rests against an internal end wall of the channel, and wherein the end portion increases in width towards its end face such that the width of the end portion is greatest at the end face.

7. A loudspeaker system according to any preceding claim, wherein the elastic element has an end portion comprising an end face which rests against an internal end wall of the channel, and wherein the end portion comprises a block of material formed with a void.

8. A loudspeaker system according to any of claim 2 to claim 7, wherein the spacer is mounted to the first loudspeaker assembly and the second loudspeaker assembly rests upon the elastic element of the support bracket, and wherein the support bracket comprises a component receiving portion between the spacer and the elastic element in which an internal component forming part of the second loudspeaker assembly is at least partially received.

9. A loudspeaker system according to claim 8, wherein the component receiving portion comprises a further elastic element configured such that the component can only make direct contact with the support bracket via the further elastic element.

10. A loudspeaker system according to any of claim 2 to 7, wherein the spacer is mounted to the first loudspeaker assembly and the second loudspeaker assembly rests upon the elastic element of the support bracket, and wherein the spacer forms a component receiving portion in which an internal component forming part of the second loudspeaker assembly is at least partially received.

11. A loudspeaker system according to any of claim 8 to 10, wherein the component is a tube forming part of the second loudspeaker assembly.

12. A loudspeaker system according to any preceding claim, wherein the spacer is mounted to the first loudspeaker assembly, and wherein the second loudspeaker assembly rests upon the elastic element of the support bracket at a contact point which is located above the position of the centre of mass of the second loudspeaker assembly.

13. A loudspeaker system according to any preceding claim, wherein the elastic element comprises a thermoset polymer.

14. A loudspeaker system according to any preceding claim wherein the spacer of the support bracket comprises a mounting portion for mounting the support bracket to the one of the first or second loudspeaker assemblies, and an elongate arm portion upon which the elastic element is mounted, wherein the mounting portion extends in a first plane and the arm portion extends away from the mounting portion in a second plane which is oriented at an angle to the first plane.

15. A loudspeaker system according to any preceding claim comprising at least one further support bracket, wherein the at least one further support bracket is substantially identical to the support bracket defined in any of claim 1 to 14, and wherein the support bracket and at least one further support bracket support the entire weight of the second loudspeaker assembly upon the first loudspeaker assembly, and hold the second loudspeaker assembly in a spaced apart relation to the first loudspeaker assembly.

16. A loudspeaker system according to any of claim 1 to 14, wherein the spacer of the support bracket comprises a mounting portion for mounting the support bracket to the one of the first or second loudspeaker assemblies, and first spacer portion spaced apart from a second spacer portion, wherein the elastic element is mounted upon one of the first or second spacer portions, the elastic element having a lower stiffness than the one of the first or second spacer portions, and wherein a second elastic element is mounted upon the other one of the first or second spacer portions, the second elastic element having a lower stiffness than the other one of the first and second spacer portions, wherein the spacer is mounted upon one of the first loudspeaker assembly or the second loudspeaker assembly and the first and second elastic elements rest against the other one of the first loudspeaker assembly or the second loudspeaker assembly such that any force transmitted between the first loudspeaker assembly and second loudspeaker assembly via the bracket passes through the elastic element and second elastic element.

17. A method of manufacturing a loudspeaker system comprising:
mounting a spacer of a support bracket to one of a first loudspeaker assembly or a second loudspeaker assembly, and
sitting the second loudspeaker assembly upon the first loudspeaker assembly by inserting an elastic element of the support bracket into a channel formed in the other of the first loudspeaker assembly or the second loudspeaker assembly until the elastic element rests against a support point within the channel, the support point being positioned such that the support bracket supports at least part of the weight of the second loudspeaker assembly upon the first loudspeaker assembly, and in a spaced apart relation to the first loudspeaker assembly.

18. A method according to claim 17, wherein the spacer is mounted to the first loudspeaker assembly and the elastic element is inserted into a channel formed in the second loudspeaker assembly, wherein the method comprises the further steps of:
inserting a component of the second loudspeaker assembly into an enclosure of the second loudspeaker assembly such that the component passes through a component receiving portion of the support bracket, and
securing the component to the loudspeaker driver.

19. A method according to claim 18, wherein the component is an elongate tube, and wherein the elongate tube is inserted into a hole formed in the enclosure of the second loudspeaker assembly and subsequently moved along an axis defined by the hole until the tube engages with the HF loudspeaker driver.
